(19) United States
(12) Patent Application Publication
(10) Pub. No.: US 2002/0129605 A1
(43) Pub. Date: Sep. 19, 2002

(54) Method of running a condenser for liquidation of steam or vapor

(76) Inventors: Mikhail Levitin, Reeders, PA (US); Boris Khaytin, Reeders, PA (US)

Correspondence Address: MIKHAIL LEVITIN, P.O. Box 102, REEDERS, PA, 18352-0102, US

(21) Appl. No.: 09/808,962

(22) Filed: Mar. 16, 2001

(51) Int. Cl. F28B 1/00; F01K 9/00; F01K 17/00; F01B 31/16; F02B 1/00

(52) U.S. Cl. 60/690; 60/685

(57) ABSTRACT

The present invention relates to a system in which a process of condensing steam or vapor is used for cooling or heating an ambient environment. An increase in the effectiveness of the condensing process is achieved by adjusting the input of steam or vapor into the condenser.

### BACKGROUND OF THE INVENTION

The increased efficiency of the preservation of food and medical products substantially affected human longevity and the quality of life. To satisfy the demand for an effective and inexpensive method of preserving large amounts of products an efficient and reliable thermal control system is required. Using the condensing processes wherein steam is condensed in heating systems or different vapors, for example refrigerant vapor, are condensed in cooling systems has effectively satisfied many of these needs.

It is known that in the case of an interruption in the input of vapor or steam into a condenser a liquid film, which covers the heat exchanging space, is formed during condensation. The resistance to the heat exchange from one media to another is increased. Accordingly, the method of input of steam or vapors to the condenser is an important factor in the effectiveness of the condensation process. At the beginning of the process it is necessary to condense the greatest amount of vapor or steam. Some time later this quantity of vapor or steam is reduced because of the decreasing rate of heat transferring into the cooling or heating system. The final step of the process requires some reduction of the input of vapor or steam. To increase the effectiveness of the condensing process an adjustment is needed in the input of steam or vapor into the condenser.

Accordingly, a need exists for improving the input of vapor or steam into the condenser. A need also exists to increase the effectiveness of the heat transfer in the condenser between vapor or steam and the temperature exchanging media.

### SUMMARY OF THE INVENTION

According to the present invention the optimum function of a condenser during the process of condensation can be achieved through the use of a controlling device, which is installed on the steam or vapor input line. That controlling device is handled by the pressure controller, which compares the value of the pressure of steam or vapor input to the condenser with the value assigned in the set point adjuster. When the controlling device is opened a portion of the steam or vapor enters into the condenser and the pressure in the steam or vapor input line is reduced. If the controller which compares the value of the pressure of steam or vapor input into the condenser with the value assigned in the set point adjuster registers that the value is equal to the set point, it closes the controlling device. At the same time when the controlling device is closed, the pressure in the steam or vapor input line is increased. If the value of the pressure of steam or vapor in the input line becomes equal to the assigned value in the set point adjuster, the controlling device is opened.

According to the second embodiment of the present invention the temperature controller compares the value of the temperature of condensation in the steam or vapor input line to the temperature in the condenser. When the controlling device is opened, a portion of steam or vapor enters the condenser and the pressure is reduced in the steam or vapor input line of the condenser. The temperature controller compares the temperature of the condenser in a steam or vapor input line to the temperature level assigned in the set point adjuster. If that value is equal to the set point the controlling device is closed. At the same time when the controlling device is closed, the temperature is increased in the steam or vapor input line. If the temperature of the steam or vapor in the input line becomes equal to the temperature level assigned in the set point adjuster, the controlling device is opened.

According to the third embodiment of the present invention the pressure controller compares the value of the pressure of the condensation being drawn off from the condenser with the value assigned at the set point adjuster. A portion of steam or vapor enters the condenser through the open controlling device installed on the steam or vapor input line of the condenser. The pressure is increased in the line drawing off the condensation from the condenser. The pressure controller compares the value of the pressure in the line drawing off the condensation from condenser to the value assigned in the set point adjuster. If that value is equal to the set point, the controlling device is closed. At the same time when the controlling device is closed the pressure is reduced in the line drawing off the condensation from the condenser. If the value of the pressure in the line drawing off the condensation from the condenser becomes equal to the value assigned in the set point adjuster, the controlling device is opened.

According to the fourth embodiment of the present invention the temperature controller compares the temperature of condensation in the line drawing off from the condenser with the temperature level assigned in the set point adjuster. A portion of steam or vapor enters the condenser through the open controlling device installed on the steam or vapor input line of the condenser. The temperature is increased in the line drawing off the condensation from the condenser. The temperature controller compares the temperature in the line drawing off the condensation from the condenser to the value assigned in the set point adjuster. If that value is equal to the set point, the controlling device is closed. At the same time when the controlling device is closed, the temperature is reduced in the line drawing off condensation from the condenser. If the temperature in the line becomes equal to the temperature level assigned in the set point adjuster, the controlling device is opened.

Due to the interrupted character of the input of vapor or steam into the condenser, the film of condensation on the heat exchanging space is thinner than in existing systems or totally disappears. Therefore, the resistance to the heat transferring process is reduced and the effectiveness is increased. In addition, a deep sub-cooling process of condensation is achieved, so that the energy of steam or vapor is used more efficiently. In the case of condensing vapor of refrigerant, the sub-cooling increases the effectiveness of refrigeration to a significant degree.

The above described and many other features and attendant advantages of the present invention will become apparent as the invention becomes better understood by reference to the following detailed description when considered in conjunction with the accompanying drawing.

### DESCRIPTION OF THE DRAWING

A detailed description of the preferred embodiment of the invention will be made with reference to the accompanying drawing.

FIG. 1 shows a condenser unit in accordance with preferred embodiment of the present invention.

FIG. 2 shows a condenser unit in accordance with the second embodiment of the present invention.

FIG. 3 shows a condenser unit in accordance with the third embodiment of the present invention.

FIG. 4 shows a condenser unit in accordance with the fourth embodiment of the present invention.

### DETAILED DESCRIPTION OF THE DRAWING

The following is a detailed description of the best presently known mode of carrying out the invention. This description is not being taken in a limiting sense, but is made merely for the purpose of illustrating the general principles of the invention. The scope of the invention is defined by the appended claims.

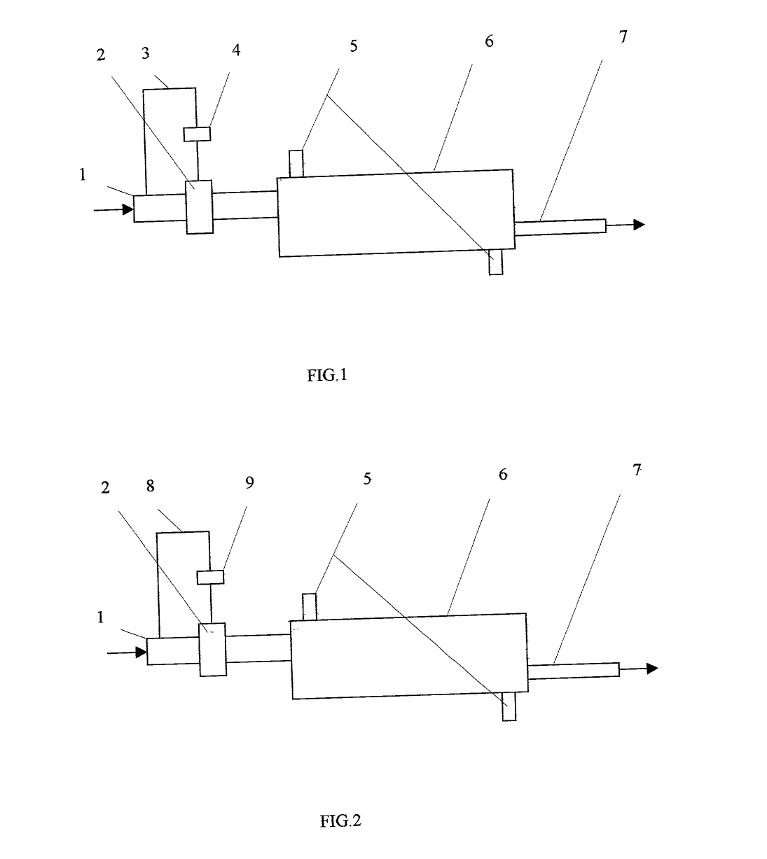

The condenser 6 (see FIG. 1) with pipes 5 for the flow of cooling media is connected to steam or vapor input line 1 and discharges the condensation through line 7, a controlling device 2 with set point adjuster is installed on said line 1, a pressure controller 4 is connected to line 1 by link 3 and connected to the controlling device 2. When a portion of steam or vapor enters the condenser 6 through the open controlling device 2, the pressure in steam or vapor input line 1 is reduced. The pressure controller 4 compares the value of the pressure of steam or vapor input to the condenser 6 with the value assigned in the set point adjuster and, if that value is equal to the set point, it closes the controlling device 2. At the same time when the controlling device 2 is closed, the pressure in steam or vapor input line 1 is increased. If the value of the pressure of steam or vapor in said line 1 becomes equal to the value assigned in the set point adjuster, the controlling device 2 is opened.

According to the second embodiment of the present invention the condenser 6 (see FIG. 2) with pipes 5 for the flow of cooling media is connected to steam or vapor input line 1 and discharges the condensation through line 7, a controlling device 2 with set point adjuster is installed on said line 1, a temperature controller 9 is connected to the line 1 by link 8 and is connected to the controlling device 2. When a portion of steam or vapor enters the condenser 6 through the open controlling device 2, the temperature in steam or vapor input line 1 is reduced. The temperature controller 9 compares the temperature level of steam or vapor input to the condenser 6 with the value assigned in the set point adjustment and, if the value is equal to the set point, closes the controlling device 2. At the same time when the controlling device 2 is closed, the temperature in said steam or vapor input line 1 is increased. If the value of the temperature of steam or vapor in said line 1 becomes equal to the value assigned in the set point adjustment, the controlling device 2 is opened.

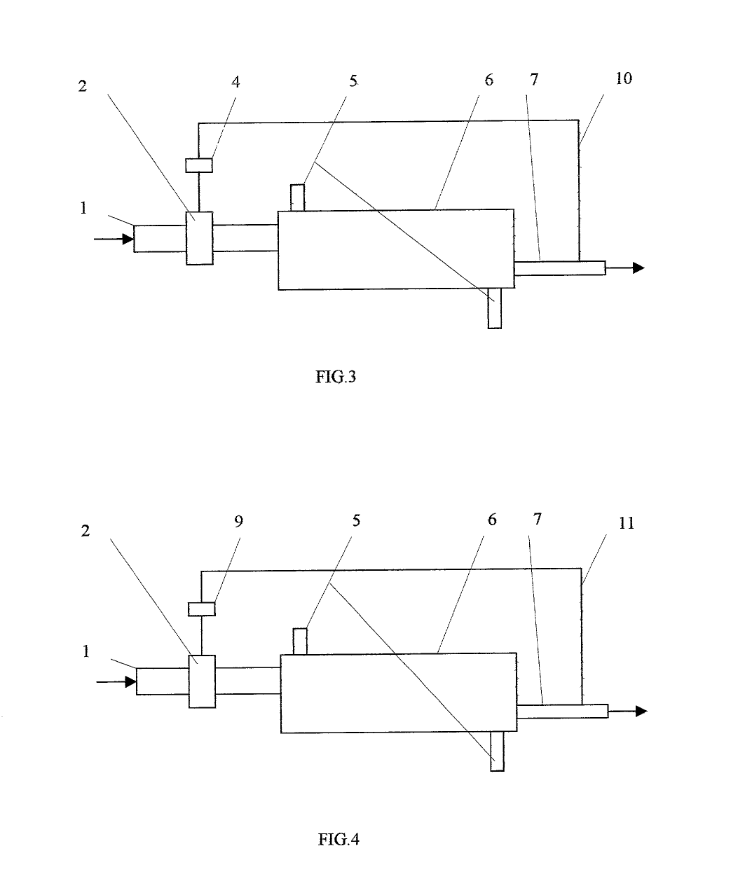

According to the third embodiment of the present invention the condenser 6 (see FIG. 3) with pipes 5 for the flow of cooling media is connected to steam or vapor input line 1 and discharges the condensation through line 7, a controlling device 2 with set point adjuster is installed on said line 1, a pressure controller 4 is connected to line 7 by link 10 and connected to the controlling device 2. When a portion of steam or vapor enters the condenser 6 through the open controlling device 2, the pressure in steam or vapor input line 1 is reduced. The pressure controller 4 compares the value of the pressure of condensation discharged from the condenser 6 with the value assigned in the set point adjuster and, if that value is equal to the set point, closes the controlling device 2. At the same time when the controlling device 2 is closed, the pressure in line 7 is reduced and the condensation from the condenser 6 is discharged off If the value of the pressure of the condensation in said line 7 becomes equal to the value assigned in the set point adjuster, the controlling device 2 is opened.

According to the fourth embodiment of the present invention the condenser 6 (see FIG. 4) with pipes 5 for the flow of cooling media is connected to line 1 and discharges the condensation through line 7, a controlling device 2 with set point adjuster is installed on said line 1, a temperature controller 9 is connected to the line 7 by link 11 and connected to the controlling device 2. When a portion of steam or vapor enters the condenser 6 through the open controlling device 2, the temperature in steam or vapor input line 1 is reduced. The temperature controller 9 compares the temperature level of the condensation discharged from the condenser 6 with the value assigned in the set point adjuster and, if that value is equal to the set point, closes the controlling device 2. At the same time when the controlling device 2 is closed, the temperature in said line 7 is reduced and the condensation from the condenser 6 is discharged. If the value of the temperature of the condensation in said line 7 becomes equal to the value assigned in the set point adjustment, the controlling device 2 is opened.

Although the present invention has been described in terms of the preferred embodiment above, numerous modification and/or additions to the above-described preferred embodiment would be readily apparent to one skilled in the art. It is intended that the scope of the present invention extends to modifications and/or additions and that the scope of the present invention is limited solely by the claims set forth below.

What is claimed:

1. The method of running a condenser for liquidation of steam or vapors having pipes and which is connected to the steam or vapor input line and to the line discharging condensation from said condenser, a controlling device installed on said steam or vapor input line, a pressure controller connected by a link to said steam or vapor input line and connected to said controlling device, said method consisting of the following steps:
closing a controlling device when pressure in said steam or vapor input line is reduced,
opening a controlling device when pressure in said steam or vapor input line is increased.

2. A condenser for liquidation of steam or vapors having pipes and connected to a steam or vapor input line and a line discharging off condensation from said condenser, a controlling device installed on said steam or vapor input line, a pressure controller connected by a link to said steam or vapor input line and connected to said controlling device.

3. The method of running a condenser for liquidation of steam or vapors, said condenser having nipples and connecting to a steam or vapor input line and to a line discharging off condensation from said condenser, a controlling device installed on said steam or vapor input line, a temperature controller connected by a link to said steam or vapor input line and connected to said controlling device, said method consisting of the following steps:
closing a controlling device when temperature is reduced in the steam or vapor input line,
opening a controlling device when pressure is increased in the steam or vapor input line.

4. A condenser for liquidation of steam or vapors having nipples and connected to a steam or vapor input line and to a line discharging condensation from said condenser, a controlling device installed on said steam or vapor input line, a temperature controller connected by a link to said steam or vapor input line and connected to said controlling device.

5. The method of running a condenser for liquidation of steam or vapors having pipes and connecting to steam or vapor input line and to a line discharging condensation from said condenser, a controlling device installed on said steam or vapor input line, a pressure controller connected by a link to said line discharging condensation from said condenser and connected to said controlling device, said method consisting of the following steps:
closing a controlling device when pressure is increased in said line discharging condensation from said condenser,
opening a controlling device when pressure is reduced in said line discharging condensation from said condenser.

6. A condenser for liquation of steam or vapors having pipes and connected to a steam or vapor input line and to a line discharging condensation from said condenser, a controlling device installed on said steam or vapor input line, a pressure controller connected by a link to said line discharging condensation from said condenser and connected to said controlling device.

7. The method of running a condenser for liquidation of steam or vapors, said condenser having pipes and which is also connected to a steam or vapor input line and to a line discharging condensation from said condenser, a controlling device installed on said steam or vapor input line, a temperature controller connected by a link to said line discharging condensation from said condenser and connected to said controlling device, said method consisting of the following steps:
closing a controlling device when temperature is increased in said line discharging condensation from condenser,
opening a controlling device when temperature is reduced in said line discharging condensation from said condenser.

8. A condenser for liquidation of steam or vapors having pipes and connected to a steam or vapor input line and a line discharging condensation from said condenser, a controlling device installed on said steam or vapor input line, a temperature controller connected by a link to said line discharging condensation from said condenser and connected to said controlling device.
